(19) United States
(12) Patent Application Publication
(10) Pub. No.: US 2015/0312188 A1
(43) Pub. Date: Oct. 29, 2015

(54) DISTRIBUTED POLICY ENFORCEMENT FOR ENTERPRISE COMMUNICATIONS

(71) Applicant: Actiance, Inc., Redwood City, CA (US)

(72) Inventors: Steven White, Woodinville, WA (US); John Onusko, Garden Valley, CA (US)

(21) Appl. No.: 14/694,736

(22) Filed: Apr. 23, 2015

Related U.S. Application Data
(60) Provisional application No. 61/983,168, filed on Apr. 23, 2014.

(51) Int. Cl. H04L 12/58; H04M 3/42; H04L 29/06

(52) U.S. Cl. CPC H04L 51/12; H04L 51/046; H04L 65/1076; H04M 3/42144

(57) ABSTRACT

An active compliance engine used to control/restrict communication or collaboration is provided. The active compliance engines may include a content inspection module that inspects the content of a message for inappropriate language or information. Content could be an instant message, content of an attached file, speech from a voice session, sign language from a video session, or content shared through desktop sharing. The active compliance engines may include a content tagging module that tags inspected content. Ethical wall rules are used in the inspection of participants to a communication to see whether they are allowed to communicate or collaborate with each other. A communication management module manages communications or event based on an inspection.

### CROSS-REFERENCES TO RELATED APPLICATIONS

This Application claims priority to and the benefit of U.S. Provisional Patent Application No. 61/983,168, filed Apr. 23, 2014, and entitled “DISTRIBUTED POLICY ENFORCEMENT FOR ENTERPRISE COMMUNICATIONS”.

### BACKGROUND OF THE INVENTION

The present disclosure relates generally to the field of information security infrastructure. Specifically presented are methods and systems for distributed policy enforcement for enterprise communications.

Companies are striving to connect across disparate enterprise computer systems to form communities. This is so that users can access and share information using enterprise resources no matter where they might be or their employment at a given firm. This can allow employees of various organizations to collaborate more efficiently. Of course, security is one concern in allowing access to a company's internal servers from outside as well has what information may be shared with whom.

Accordingly, what is desired is to solve problems relating to policy enforcement for enterprise communications, some of which may be discussed herein. Additionally, what is desired is to reduce drawbacks relating to distributed policy enforcement for enterprise communications, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 depicts a simplified diagram of an enterprise-based architecture for implementing one of the embodiments.

FIG. 2 depicts a simplified diagram of a distributed architecture for implementing one of the embodiments.

FIG. 3 is a simplified flowchart of a method for distributed policy enforcement for enterprise communications in one embodiment.

FIG. 4 illustrates one scenario of the method of FIG. 3 for distributed policy enforcement for enterprise communications in one embodiment.

FIG. 5 illustrates how communications are managed in one example for the scenario of FIG. 4 for distributed policy enforcement for enterprise communications in one embodiment.

FIG. 6 illustrates how communications are managed in another example for the scenario of FIG. 4 for distributed policy enforcement for enterprise communications in one embodiment.

FIG. 7 illustrates cloud-based distributed policy enforcement for enterprise communications in one embodiment.

FIG. 8 illustrates distributed active compliance between on-premise and cloud resources for distributed policy enforcement for enterprise communications in one embodiment.

FIG. 9 depicts a simplified diagram of a distributed system for implementing one of the embodiments.

FIG. 10 is a simplified block diagram of components of a system environment by which services provided by the components of an embodiment system may be offered as cloud services, in accordance with an embodiment of the present disclosure.

FIG. 11 illustrates an exemplary computer system, in which various embodiments of the present invention may be implemented.

### DETAILED DESCRIPTION OF THE INVENTION

### I. Terminology

A communication—a used herein a communication refers to the act of imparting or exchanging of information, a collaboration, or the means of connection between entities that are parties to a communication or collaboration. Some examples of a communication include a voice call, a conference call, a Voice over Internet Protocol (VoIP) call, a video call, an instant messaging (IM) session, a persistent chat discussion, etc. together with the means that provide such. In various embodiments, communications (e.g., their establishment, content, means, and lifecycle) are controlled by ethical wall rules.

A communication event—as used herein a communication event refers to one or more actions or interactions associated with a communication. Some examples of a communication event include establishing a communication session, adding a user to a multi-party communication, inviting a user to join a communication (e.g. invite or add a user to a chat room membership), updating user metadata, etc.

Active compliance engine—as used herein refers to hardware and/or software elements that control/restrict communications or collaboration or that restrict communication events. In one aspect, an active compliance engine includes a content inspection module, a content tagging module, a repository of ethical wall rules, and a communication manager module.

A content inspection module as used herein refers to hardware and/or software elements that inspects a communication or collaboration or communication event to determine whether the inspection satisfies predetermined criteria. The content inspection module may inspect contents of a communication, metadata associated with the communication, or determine a type or category of a communication event. The content inspection module may include one or more additional modules or plugins to handle a variety of types or means of communicating in order to perform an inspection, such as for electronic messages (e.g., email and instant messages), speech from a voice session, sign language from a video session, or content shared through desktop sharing applications. The content inspection module may include or have access to a variety of rules, inspection sets, or decision points used to determine whether the inspection satisfies the predetermined criteria.

In general, rules, inspection sets, or decision points used to determine whether an inspection of a communication or collaboration or communication event satisfies predetermined criteria are referred to herein as ethical wall rules. For example, an inspection of participants of an instant messaging session may be made according to one or more ethical wall rules to see if one or more of the participations are allowed to communicate or collaborate with each other or whether the subject matter of the conversation is prohibited.

A content tagging module as used herein refers to hardware and/or software elements that tag a communication or collaboration or communication event. In one aspect, based on one or more recommendations or decisions by the content inspection module, the content tagging module may tag or annotate the communication or collaboration, content of the communication, associated metadata, and/or associated communication event with one or more tags. Some examples of tags include permission-type tags that identify one or more permissions applicable to the inspection, such as blocked or allowed, characterization-type tags that characterize a communication, or its contents or participants, privilege or confidentiality tags, or the like.

A communication manager module as used herein refers to hardware and/or software elements that manage a communication or collaboration or communication event based on an inspection and/or associated tags. The communication manager module may manage an inspection, for example, by blocking or allowing a communication to be initiated or to continue or by performing one or more actions based on a communication event. The communication manager module may further manage an inspection, for example, by generating one or more notifications to one or more entities that are not participating in a communication or collaboration associated with the inspection. In some aspects, the communication manager module may communicate with a variety of devices in order to manage communications, provide record keeping and audit logs, provide notification of compliance or non-compliance, and the like.

A community directory as used herein refers to hardware and/or software elements that provides information associated with entities or organizations participating in one or more communities that engage in one or more communications. Each entity or organization can implement or host all or part of an active compliance engine as discussed above for communication with a community. The community directly hosts information about all users, participants, etc. in the community who fall under restrictions of the entity or organization. The community directory of multiple entities or organizations can be leveraged by the active compliance engine to enforce policies in a community across disparate users, entities, and organizations. Some examples of information stored by a community directory can include local and global identifiers for users (e.g., employee ID), First/Last Name, Firm/Division, communication address (email, IM ID or buddy name, phone number, etc.) for specific networks (Skype, Lync IM, Thompson-Reuters Eikon ID, Enterprise Phone number, etc.), role-based or permission based attributes (e.g., user is a “Foreign-Exchange Trader”, “Foreign-Exchange Rate-Setter”. . . ), and the like.

II. Distributed Ethical Wall Rules

Historically, ethical wall rules have been applied specifically within a firm. A firm can write rules that allow/disallow communications between different groups associated with the firm. These could be internal groups (internal traders with internal rate-setters) or between firms (Bank-A traders with Bank-B rate-setters).

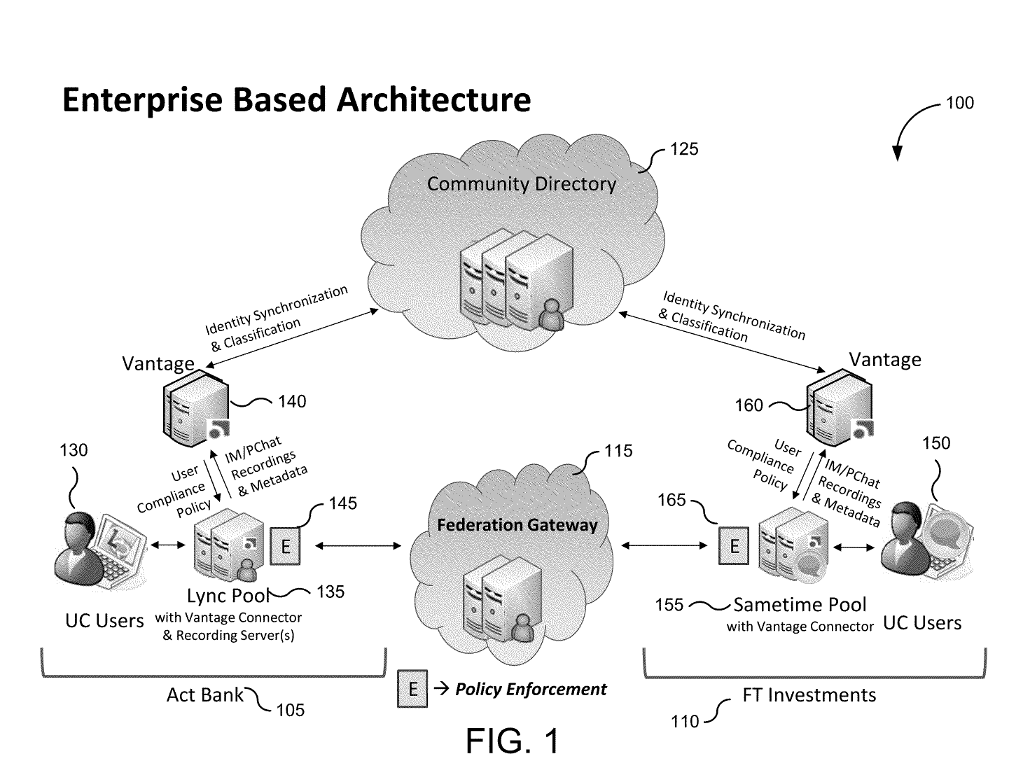

Distributed ethical wall rules refers to performing communications with among multiple active compliance engines each associated with one or more entities or organizations or between logical partitions each associated with at least one entity or organization that are managed by a single active compliance engine. FIG. 1 depicts a simplified diagram of enterprise-based architecture 100 for implementing one of the embodiments.

In this example, architecture 100 includes enterprise 110 (“Act Bank”), enterprise 120 (“FT Investments”), federation gateway 115, and community directory 125. Enterprise 110 includes unified communications users 130 that communicate using unified communications server 135 (e.g., “Lync pool”). Enterprise 110 further includes communications management server 145 that implements and enforces policy set 145 for communication events associated with users 130 and server 135. Similarly, enterprise 120 includes unified communications users 150 that communicate using unified communications server 155 (e.g., “Sametime pool”). Enterprise 120 further includes communications management server 160 that implements and enforces policy set 165 for communication events associated with users 150 and server 155.

Federation gateway 115 includes hardware and/or software elements that allow users 130 to communicate with users 150. To be federated means users are able to send messages from one network to the other. This is not the same as having a client that can operate with both networks. Users 130 and 150 interact with both independently. In part to enable this, information about each organization is collected in communicate directory 125.

Historically, ethical wall rules have been applied specifically within a firm. For example, a firm can write rules that allow/disallow communications between different groups associated with the firm. These could be internal groups (internal traders with internal rate-setters) or between firms (Bank-A traders with Bank-B rate-setters). As illustrated, policies 145 and 165 may be applied at the federation level to manage communication events prior to leaving the organizations infrastructure.

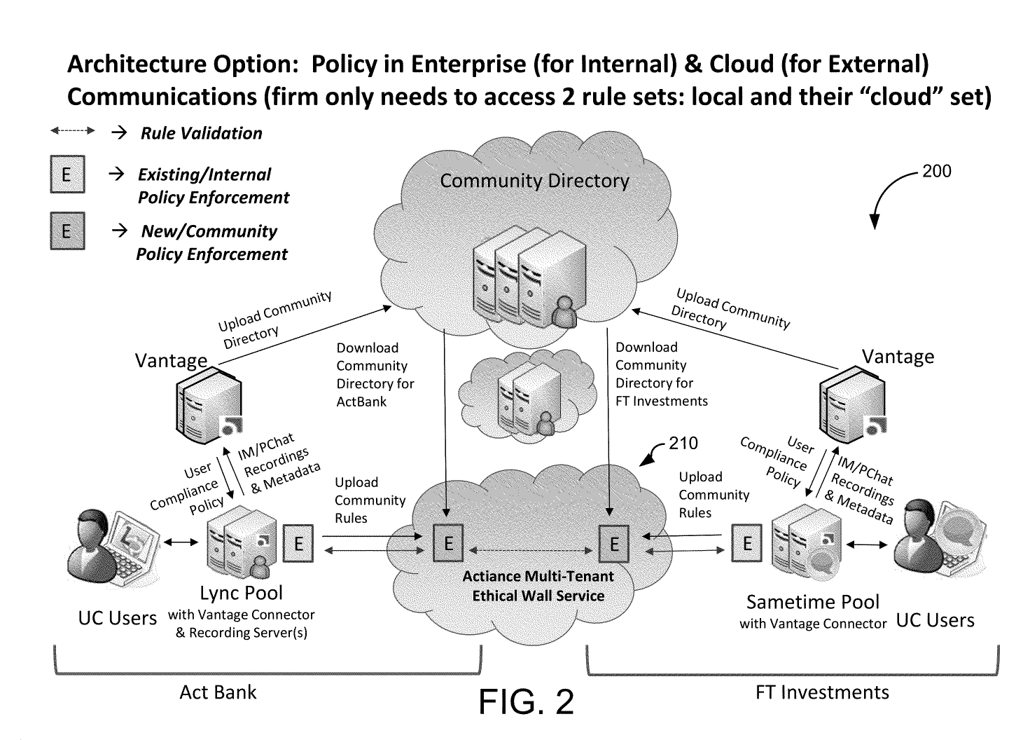

In one embodiment, an active compliance engine (also known as an ethical wall engine) of one organization can communicate with other active compliance engines of other organizations to determine ethical wall rules in other firms. FIG. 2 depicts a simplified diagram of distributed architecture 200 for implementing one of the embodiments. In this example, federation gateway 115 is expanded or replaced by ethical wall service 210. Service 210 facilitates the communication between active compliance engines of organizations and the sharing of ethical wall rules with other firms. Communication may be based on a web API or other distributed call.

In one aspect, in order for a communication to be initiated or to host participants, or for a communication event to occur, each active compliance engine of each firm in a community coordinates to allow the communication or communication event to occur. If one or more active compliance engine determines that one or more ethical wall rules have not be satisfied, one or more conditions have not been met, or other predetermined criteria fails to be satisfied, the communication or communication event will NOT be allowed.

In various embodiments, the disallowing active compliance engine or another active compliance engine based on one or more instructions when an ethical wall rule disallows a communication or communication event, generates one or more notifications that return a reason based on the rule. For example, a notification may be generated and sent using one or more communication mediums or modalities that indicates, “C-Bank does not allow this action because it does not allow traders to communicate with more than 3 firms”.

In some embodiments, each active compliance engine proactively monitors changes to ethical wall rules. For example, if a set of rules have changed between an ethical wall check, a communication or communication event can be immediately managed according to any changed rules. For example, a role associated with a user may change to a role where the user us NOT allowed to communicate with one or more external traders. Active compliance engine may cause the user to be removed from a communication, such as a telephone call or instant messaging session.

Where select participant firms do NOT have an ethical wall engine or an active compliance engine that is compatible with or in communication with other active compliance engines in a community, the active compliance engine of one firm cannot manage (e.g., block or explicitly allow) a communication in a distributed sense. Ethical wall rules of other firms may account for these participants (whether they are known or not known in a community directory). In one aspect, an active compliance engine of a not connected firm can block a communication event on its side, either allowing or blocking a user from a given communication.

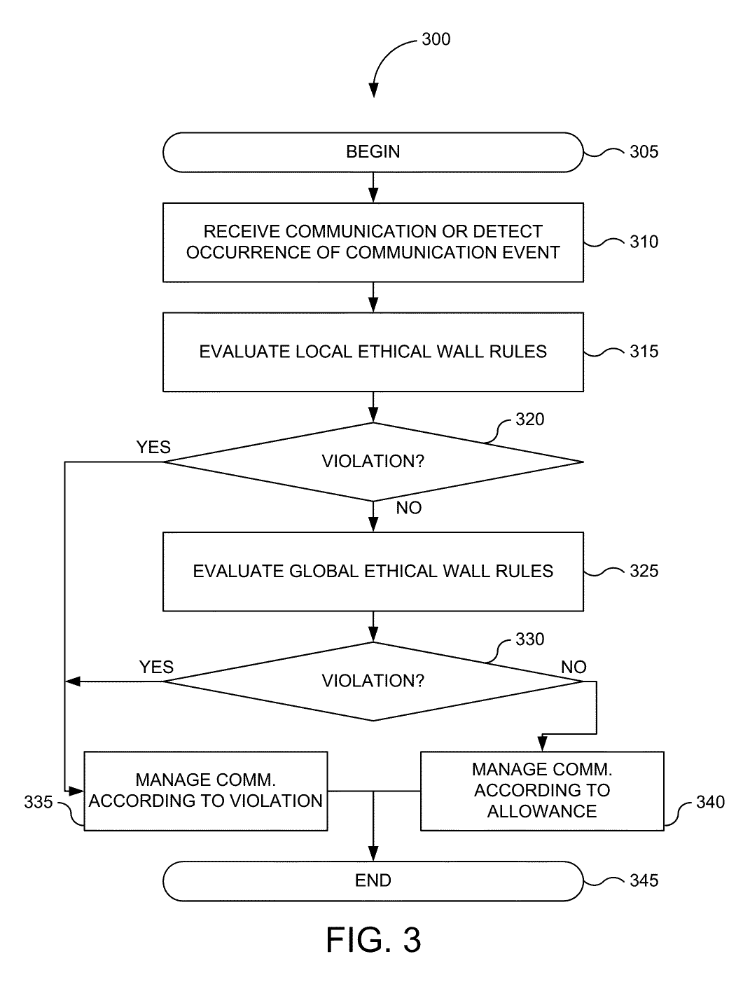

FIG. 3 is a simplified flowchart of method 300 for distributed policy enforcement for enterprise communications in one embodiment. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 305.

In step 310, a communication is received or occurrence of a communication event is detected. A communication can include any type of electronic message (e.g., email, instant message, social media communication, SMS, text, etc.), a phone call, or the like. A communication refers to the act of imparting or exchanging of information, a collaboration, or the means of connection between entities that are parties to a communication or collaboration. Further examples of a communication include a voice call, a conference call, a Voice over

Internet Protocol (VoIP) call, a video call, an instant messaging (IM) session, a persistent chat discussion, etc. together with the means that provide such. In various embodiments, communications (e.g., their establishment, content, means, and lifecycle) are controlled by ethical wall rules. A communication event refers to one or more actions or interactions associated with a communication. Further examples of a communication event include establishing a communication session, adding a user to a multi-party communication, inviting a user to join a communication (e.g. invite or add a user to a chat room membership), updating user metadata, etc. In some embodiments, a communication or related event can be received directly by a communications manager or forwarded by another communications manager.

In step 320, an evaluation is performed as to whether the communication (or event) violates one or more local ethical wall rules. Local ethical wall rules generally refer to one or more rules, policies, or filters that apply specifically to the organization receiving the communication or detecting the event. If a determination is made in step 320 that no violation of the local ethical wall rules has been found, in step 325, an evaluation is performed as to whether the communication (or event) violates one or more global ethical wall rules. Global ethical wall rules generally refer to one or more rules, policies, or filters that apply to other organizations. An active compliance engine (also known as an ethical wall engine) of the organization can communicate with other active compliance engines of other organizations to collect a set of global ethical wall rules.

If a determination is made in step 320 that a violation of the local ethical wall rules or in step 330 that a violation of the global ethical wall rules has been found, in step 335, the communication (or event) is managed according to the violation. The communication can be blocked, filtered, edited, or otherwise handled according to one or more actions specified by any violated policy. If a determination is made in step 330 that a violation of has not been found, the communication is managed in step 340 according to allowance of the communication. In some embodiments, the communication can be logged, modified with a disclaimer, etc. before being allow to leave an organizations network.

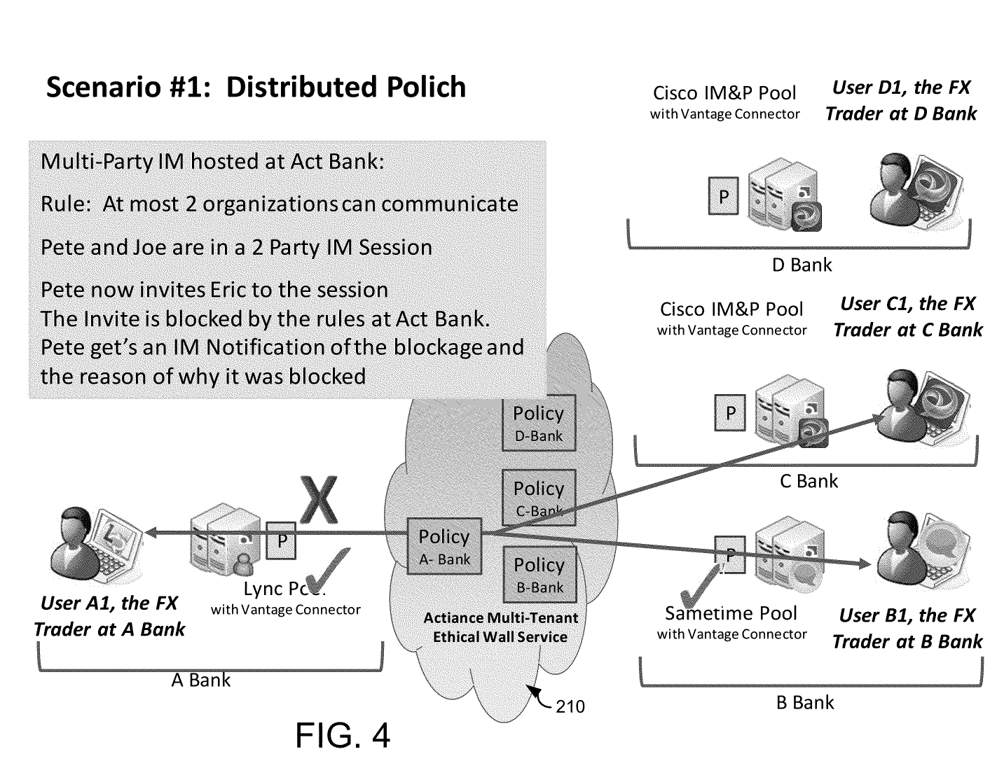

FIG. 4 illustrates one scenario of method 300 of FIG. 3 for distributed policy enforcement for enterprise communications in one embodiment. In this example, a multi-party instant messaging session is being hosted by “A Bank.” User A1 is a FX trader with A, user B1 is a FX trader a “B Bank,” user C1 is a FX trader a “C Bank,” and user D1 is a FX trader a “D Bank.” A has a policy that at most 2 organizations at a time can participate in a chat session. If A1 and B1 are participating in the session and B1 invites C1 to the session, historically there would be no means for A's policy to be enforced. In one embodiment, because A's policy has been shared with B, C, and D using service 210, an event associated with C1's invitation to the session can be detected and a determination made whether the event violates A's policy. The invite can be blocked by implementing A's policy. A notification can be sent to those involved in the session informing them of the block and the reasons.

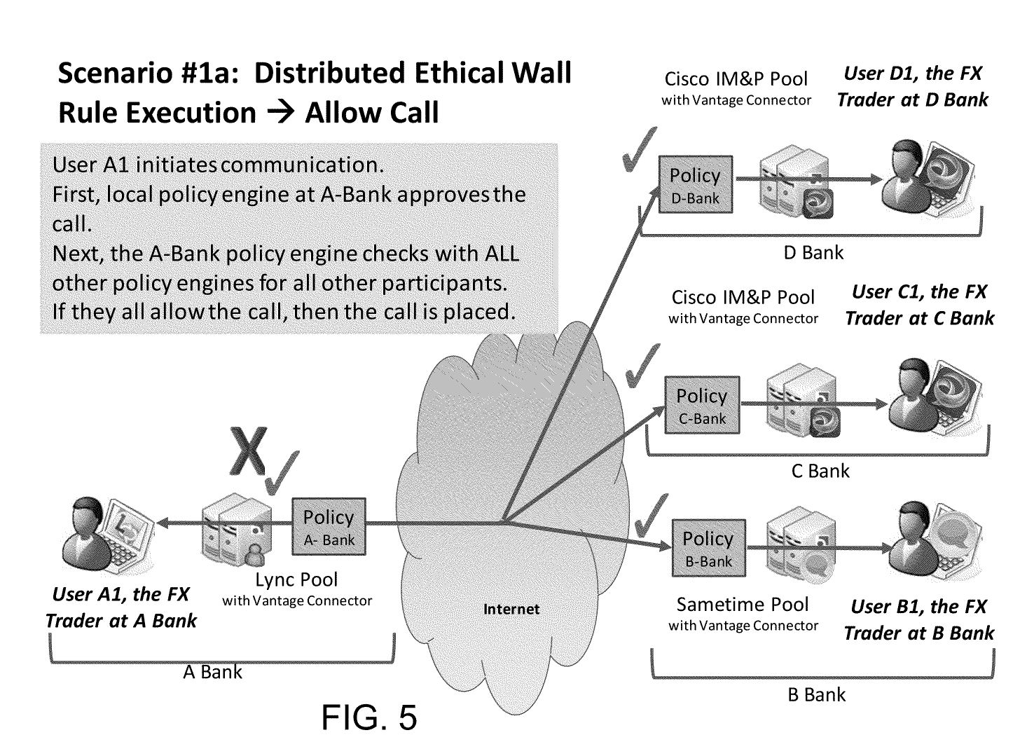

FIG. 5 illustrates how communications are managed in one example for the scenario of FIG. 4 for distributed policy enforcement for enterprise communications in one embodiment.

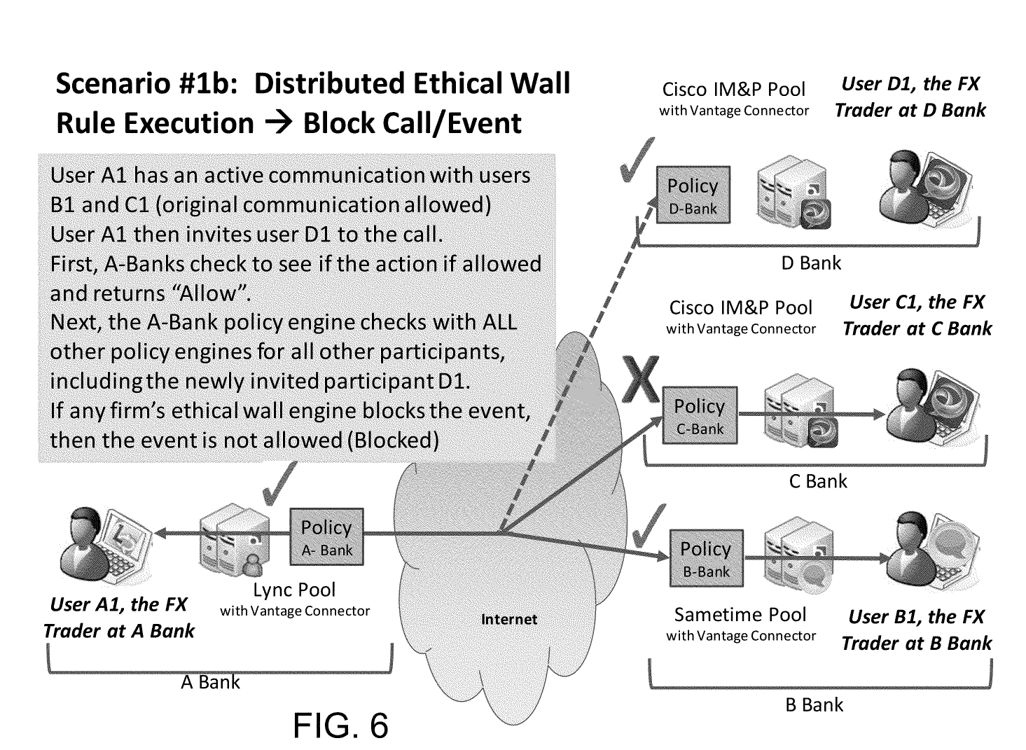

FIG. 6 illustrates how communications are managed in another example for the scenario of FIG. 4 for distributed policy enforcement for enterprise communications in one embodiment.

### III. Cloud-Based Distributed Ethical Wall Rules

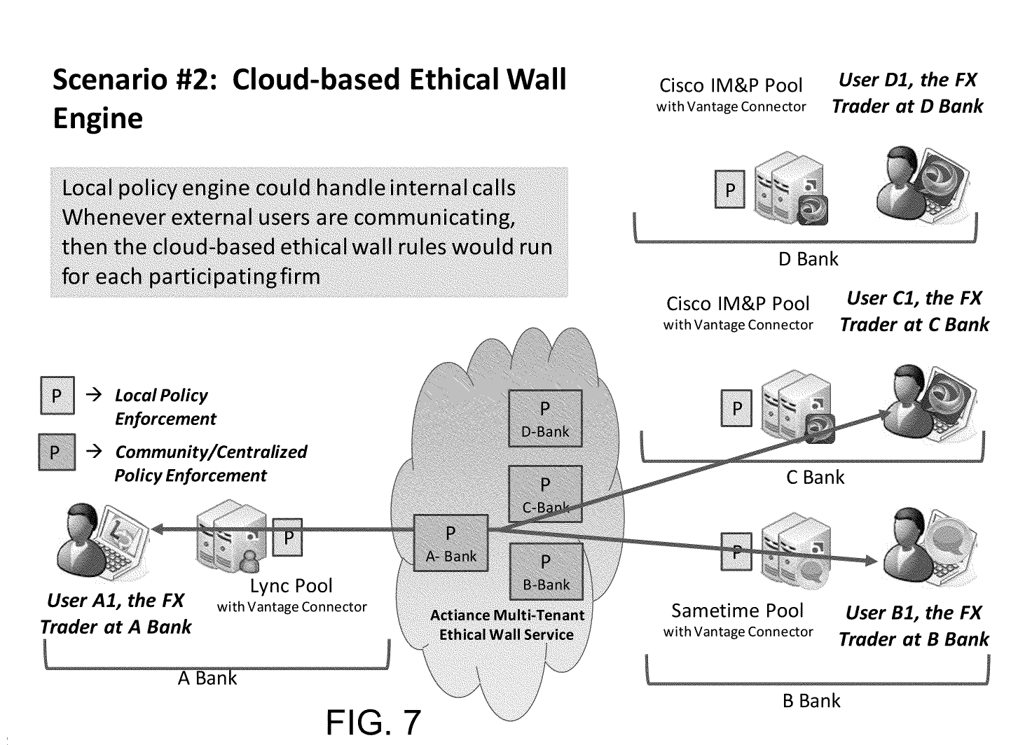

In some embodiments, ethical wall rules can be enforced locally by an entity or organizations and/or the rules could be enforced in the cloud. FIG. 7 illustrates cloud-based distributed policy enforcement for enterprise communications in one embodiment.

In one aspect, local rules are good for high availability, allowing local communications in the event if network access to the cloud ethical wall rule service is down. Whenever a call happens with external participants, the cloud ethical wall rules would be invoked. The rules engine would typically be specific to each firm (and would have privacy settings). Theoretically, a community could have a common set of rules, in which case only 1 rule engine may be invoked.

Some advantages of this approach include:
1. All rules are in 1 place, avoiding the added complexity of having to call the rules engines in multiple different firms.
2. The community metadata would only be in the cloud, where access to this information between firms could be better controlled and monitored. Many firms may not want to share their user directory information with other community members
3. Performance considerations
4. Management considerations (making sure rules have been tested before release, etc.)

### IV. Hybrid Cloud-based Distributed Ethical Wall Rules

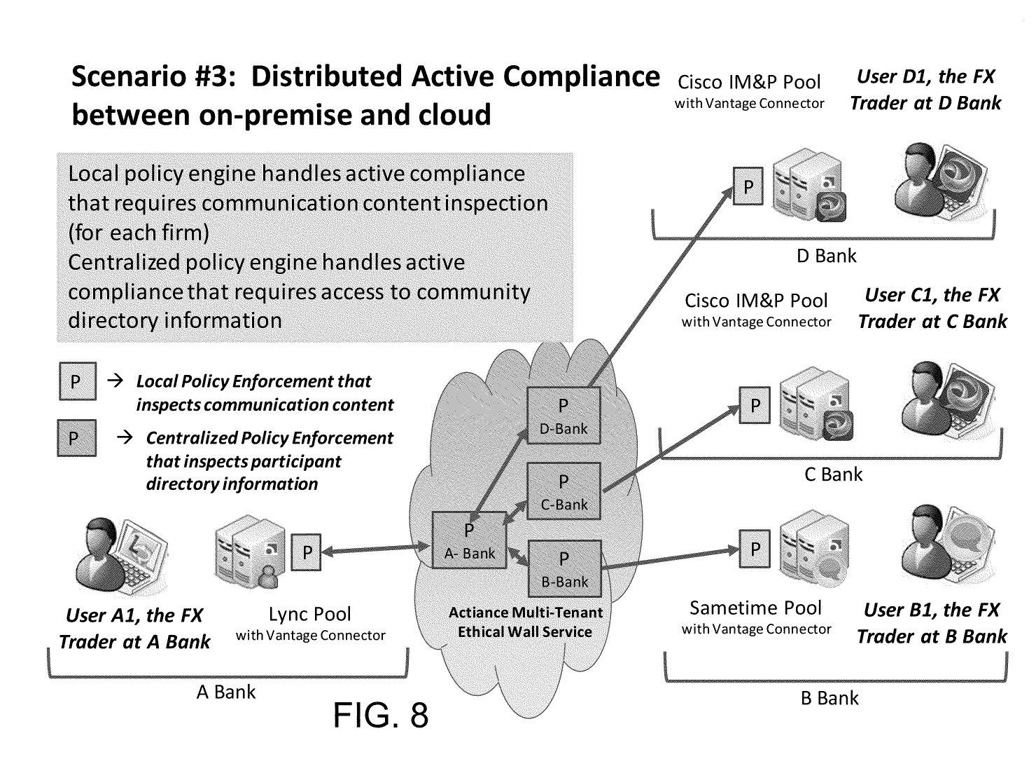

FIG. 8 illustrates distributed active compliance between on-premise and cloud resources for distributed policy enforcement for enterprise communications in one embodiment.

Typically active compliance engines have been deployed on premise. On-premise deployments means the content of the communication can be inspected, giving the local firm control over the privacy of the information. Since these messages contain sensitive content (trades), firms obviously do not want the content inspected by any other party other than the firms participating in the actual communication. Firms typically would not trust a 3rd party from doing this inspection as the 3rd party could monitor communications across the community (which is serious especially in financial service markets).

With the introduction of rich directory information about members of the community (e.g. other financial institutions) that is required for ethical wall engines and rules that enforce policy across the community, firms are put is a position to share this information with other firms or 3rd parties that would apply ethical wall rules. Many firms are reluctant to share this information with a broad set of other firms. This may be due to a number of reasons such as the privacy rights of users or whether the firm trusts or has inspected the other firm's network security to see if it meets their level of satisfaction.

By having the ethical wall rules run in data centers controlled by 1 organization (could be a firm or a neutral 3rd party), then firms can do their network security validation. They also know the location(s) of where this data is in case if there are sensitive countries or country combinations where data should not be shared.

By splitting the active compliance engine so the content inspection is done locally by each firm and the ethical walls enforcement leveraging user information from the community members is done in the cloud means that the security requirements of member firms can best be met.

FIG. 8 shows how the active compliance engine is split, where the P box at each enterprise represents the content inspection component that is run at each enterprise and the P box in the cloud represents the ethical wall engine and community user directory information that is run in the cloud.

Note that select directory information can be shared through actual communications between member firms, possibly controlled by rules of each firm. For example, the policy engine and directory could share information about users in actual conversations between the firms whose users are involved in the communication. This would effectively only share user information between firms where there is actual communication or collaboration (or possibly just that they are both members of a chat room). This level of sharing is useful for transaction resulting from the communication or supervision (watching to make sure only legitimate conversations are taking place). It also means that the actual users have someone obtained the users contact information by some other source (contact list, address book directory service, business card, etc.). This level of sharing means that the firm does not share information about ALL their users across the different members of the community.

### V. Example Scenario

In an example, 4 users (A1, B1, C1 and D1) at 4 different firms (A-Bank, B-Bank, C-Bank and D-Bank) respectively are associated in some manner with a communication. An example call might be that user A1 initiates a multi-party IM session with users B1, C1 and D1.

Example events might be:
If A1, B1 and C1 are in a persistent chat room:
   User A1 then tries to invite user D1 to the persistent chat room (in real time or in the future)
   That invite could be allowed or blocked
If A1, B1 and C1 are in a persistent chat room:
   User B1 then tries to invite user D1 to the persistent chat room (in real time or in the future)
   That invite could be allowed or blocked
If A1 is setting up a persistent chat room:
   User A1 then allows B1, C1 and D1 to participate in the chat room.
   The invites would typically be done one after another (but could be done in a batch)
   That “add user(s) event” could be allowed or blocked
If an existing persistent chat room has been created and there are 4 participants (A1, B1, C1 and D1):
At some point, the user metadata (e.g. user roles) or ethical wall rules (from any or all firms) could be updated
The system will then (based on some algorithm) would re-evaluate the rules
At this point, various actions could take place.
One possible action would be to have the user from any firm where the rules now block his participation would have the user removed from the room. A message could then be sent to the owner and removed user (and others) on the action and reason for the action.
Typically the owner would still be allowed to access to room (even if all other users are removed)

### VI. Conclusion

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. In some embodiments, the systems may be configured as a distributed system where one or more components of the system are distributed across one or more networks in a cloud computing system.

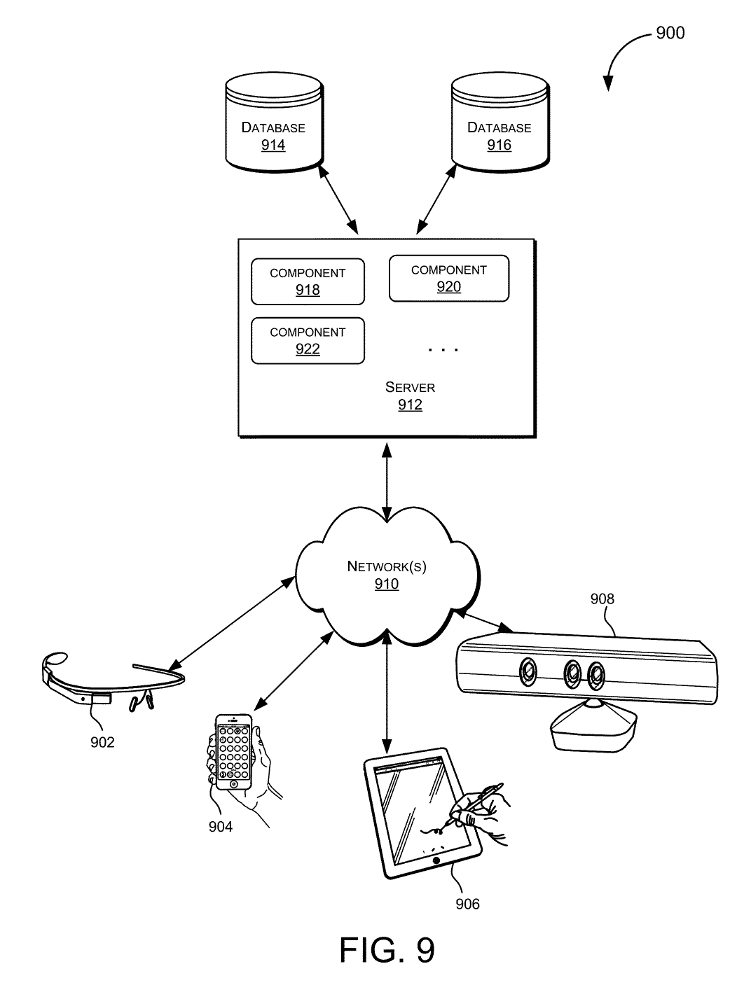

FIG. 9 depicts a simplified diagram of a distributed system 900 for implementing one of the embodiments. In the illustrated embodiment, distributed system 900 includes one or more client computing devices 902, 904, 906, and 908, which are configured to execute and operate a client application such as a web browser, proprietary client (e.g., Oracle Forms), or the like over one or more network(s) 910. Server 912 may be communicatively coupled with remote client computing devices 902, 904, 906, and 908 via network 910.

In various embodiments, server 912 may be adapted to run one or more services or software applications provided by one or more of the components of the system. In some embodiments, these services may be offered as web-based or cloud services or under a Software as a Service (SaaS) model to the users of client computing devices 902, 904, 906, and/or 908. Users operating client computing devices 902, 904, 906, and/or 908 may in turn utilize one or more client applications to interact with server 912 to utilize the services provided by these components.

In the configuration depicted in the figure, the software components 918, 920 and 922 of system 900 are shown as being implemented on server 912. In other embodiments, one or more of the components of system 900 and/or the services provided by these components may also be implemented by one or more of the client computing devices 902, 904, 906, and/or 908. Users operating the client computing devices may then utilize one or more client applications to use the services provided by these components. These components may be implemented in hardware, firmware, software, or combinations thereof. It should be appreciated that various different system configurations are possible, which may be different from distributed system 900. The embodiment shown in the figure is thus one example of a distributed system for implementing an embodiment system and is not intended to be limiting.

Client computing devices 902, 904, 906, and/or 908 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or

UNIX-like operating systems, including without limitation the variety of GNU/Linux operating systems, such as for example, Google Chrome OS. Alternatively, or in addition, client computing devices 902, 904, 906, and 908 may be any other electronic device, such as a thin-client computer, an Internet-enabled gaming system (e.g., a Microsoft Xbox gaming console with or without a Kinect® gesture input device), and/or a personal messaging device, capable of communicating over network(s) 910.

Although exemplary distributed system 900 is shown with four client computing devices, any number of client computing devices may be supported. Other devices, such as devices with sensors, etc., may interact with server 912.

Network(s) 910 in distributed system 900 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 910 can be a local area network (LAN), such as one based on Ethernet, Token-Ring and/or the like. Network(s) 910 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 902.11 suite of protocols, Bluetooth®, and/or any other wireless protocol); and/or any combination of these and/or other networks.

Server 912 may be composed of one or more general purpose computers, specialized server computers (including, by way of example, PC (personal computer) servers, UNIXO servers, mid-range servers, mainframe computers, rack-mounted servers, etc.), server farms, server clusters, or any other appropriate arrangement and/or combination. In various embodiments, server 912 may be adapted to run one or more services or software applications described in the foregoing disclosure. For example, server 912 may correspond to a server for performing processing described above according to an embodiment of the present disclosure.

Server 912 may run an operating system including any of those discussed above, as well as any commercially available server operating system. Server 912 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 912 may include one or more applications to analyze and consolidate data feeds and/or event updates received from users of client computing devices 902, 904, 906, and 908. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 912 may also include one or more applications to display the data feeds and/or real-time events via one or more display devices of client computing devices 902, 904, 906, and 908.

Distributed system 900 may also include one or more databases 914 and 916. Databases 914 and 916 may reside in a variety of locations. By way of example, one or more of databases 914 and 916 may reside on a non-transitory storage medium local to (and/or resident in) server 912. Alternatively, databases 914 and 916 may be remote from server 912 and in communication with server 912 via a network-based or dedicated connection. In one set of embodiments, databases 914 and 916 may reside in a storage-area network (SAN). Similarly, any necessary files for performing the functions attributed to server 912 may be stored locally on server 912 and/or remotely, as appropriate. In one set of embodiments, databases 914 and 916 may include relational databases, such as databases provided by Oracle, that are adapted to store, update, and retrieve data in response to SQL-formatted commands.

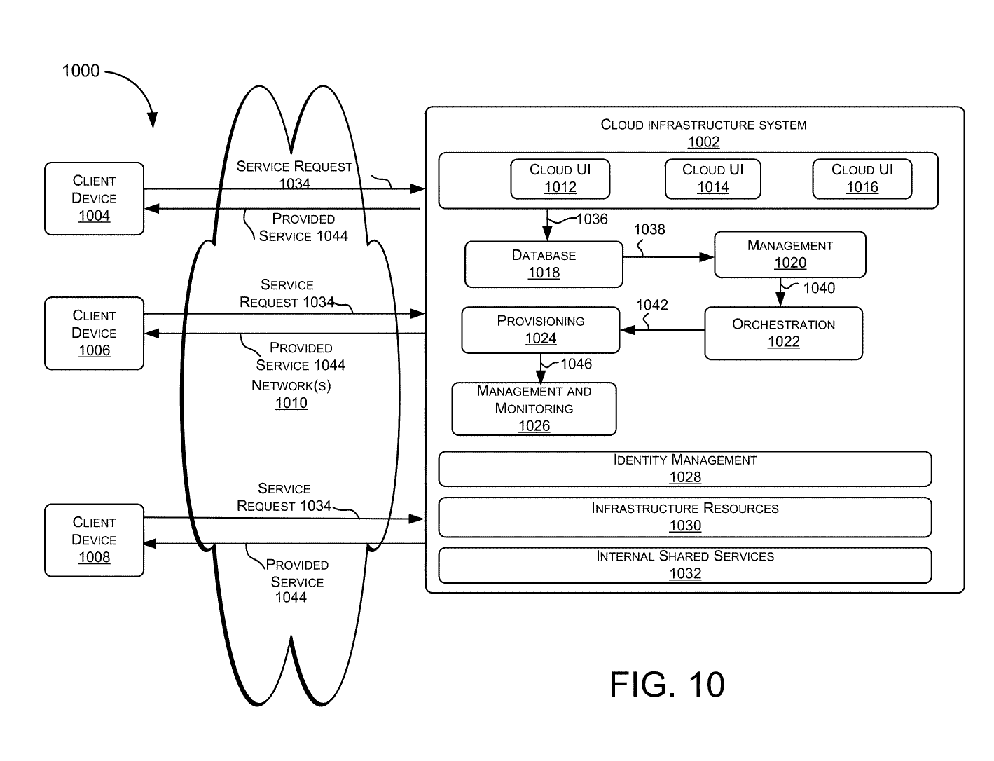

FIG. 10 is a simplified block diagram of one or more components of a system environment 1000 by which services provided by one or more components of an embodiment system may be offered as cloud services, in accordance with an embodiment of the present disclosure. In the illustrated embodiment, system environment 1000 includes one or more client computing devices 1004, 1006, and 1008 that may be used by users to interact with a cloud infrastructure system 1002 that provides cloud services. The client computing devices may be configured to operate a client application such as a web browser, a proprietary client application (e.g., Oracle Forms), or some other application, which may be used by a user of the client computing device to interact with cloud infrastructure system 1002 to use services provided by cloud infrastructure system 1002.

It should be appreciated that cloud infrastructure system 1002 depicted in the figure may have other components than those depicted. Further, the embodiment shown in the figure is only one example of a cloud infrastructure system that may incorporate an embodiment of the invention. In some other embodiments, cloud infrastructure system 1002 may have more or fewer components than shown in the figure, may combine two or more components, or may have a different configuration or arrangement of components.

Client computing devices 1004, 1006, and 1008 may be devices similar to those described above for 1002, 1004, 1006, and 1008.

Although exemplary system environment 1000 is shown with three client computing devices, any number of client computing devices may be supported. Other devices such as devices with sensors, etc. may interact with cloud infrastructure system 1002.

Network(s) 1010 may facilitate communications and exchange of data between clients 1004, 1006, and 1008 and cloud infrastructure system 1002. Each network may be any type of network familiar to those skilled in the art that can support data communications using any of a variety of commercially-available protocols, including those described above for network(s) 1010.

Cloud infrastructure system 1002 may comprise one or more computers and/or servers that may include those described above for server 1012.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1002 may include a suite of applications, middleware, and database service offerings that are delivered to a customer in a self-service, subscription-based, elastically scalable, reliable, highly available, and secure manner. In various embodiments, cloud infrastructure system 1002 may be adapted to automatically provision, manage and track a customer's subscription to services offered by cloud infrastructure system 1002. Cloud infrastructure system 1002 may provide the cloud services via different deployment models. For example, services may be provided under a public cloud model in which cloud infrastructure system 1002 is owned by an organization selling cloud services and the services are made available to the general public or different industry enterprises. As another example, services may be provided under a private cloud model in which cloud infrastructure system 1002 is operated solely for a single organization and may provide services for one or more entities within the organization. The cloud services may also be provided under a community cloud model in which cloud infrastructure system 1002 and the services provided by cloud infrastructure system 1002 are shared by several organizations in a related community. The cloud services may also be provided under a hybrid cloud model, which is a combination of two or more different models.

In some embodiments, the services provided by cloud infrastructure system 1002 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1002. Cloud infrastructure system 1002 then performs processing to provide the services in the customer's subscription order.

In some embodiments, the services provided by cloud infrastructure system 1002 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1002 may also include infrastructure resources 1030 for providing the resources used to provide various services to customers of the cloud infrastructure system. In one embodiment, infrastructure resources 1030 may include pre-integrated and optimized combinations of hardware, such as servers, storage, and networking resources to execute the services provided by the PaaS platform and the SaaS platform.

In some embodiments, resources in cloud infrastructure system 1002 may be shared by multiple users and dynamically re-allocated per demand. Additionally, resources may be allocated to users in different time zones. For example, cloud infrastructure system 1030 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1032 may be provided that are shared by different components or modules of cloud infrastructure system 1002 and by the services provided by cloud infrastructure system 1002. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1002 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1002, and the like. In one embodiment, as depicted, cloud management functionality may be provided by one or more modules, such as management module 1020, orchestration module 1022, provisioning module 1024, monitoring module 1026, and identity management module 1028. These modules may include or be provided using one or more computers and/or servers, which may be general purpose computers, specialized server computers, server farms, server clusters, or any other appropriate arrangement and/or combination.

In exemplary operation 1034, a customer using a client device, such as client device 1004, 1006 or 1008, may interact with cloud infrastructure system 1002 by requesting one or more services provided by cloud infrastructure system 1002. In certain embodiments, the customer may access a cloud User Interface (UI), cloud UI 1012, cloud UI 1014 and/or cloud UI 1016. At operation 1036, information may be stored in database 1018. Database 1018 can be one of several databases operated by cloud infrastructure system 1018 and operated in conjunction with other system elements. At operation 1038, the information may be forwarded to management module 1020. In some instances, management module 1020 may be configured to perform billing and accounting functions. At operation 1040, information is communicated to orchestration module 1022. Orchestration module 1022 may utilize the information to orchestrate provisioning of services and resources. In some instances, orchestration module 1022 may orchestrate provisioning of resources for services using the services of provisioning module 1024.

In certain embodiments, orchestration module 1022 enables the management of business processes associated with business logic. At operation 1042, upon receiving a request, orchestration module 1022 may send a request to provisioning module 1024 to allocate resources and configure those resources. Provisioning module 1024 enables the allocation of resources for the services. Provisioning module 1024 provides a level of abstraction between the cloud services provided by cloud infrastructure system 1000 and the physical implementation layer that is used to provision the resources for providing the requested services. Orchestration module 1022 may thus be isolated from implementation details, such as whether or not services and resources are actually provisioned on the fly or pre-provisioned and only allocated/assigned upon request.

At operation 1044, once the services and resources are provisioned, a notification of the provided service may be sent to customers on client devices 1004, 1006 and/or 1008 by order provisioning module 1024 of cloud infrastructure system 1002. At operation 1046, a customer's information may be managed and tracked by management and monitoring module 1026. In some instances, management and monitoring module 1026 may be configured to collect usage statistics for the services, such as the amount of storage used, the amount data transferred, the number of users, and the amount of system up time and system down time.

In certain embodiments, cloud infrastructure system 1000 may include an identity management module 1028. Identity management module 1028 may be configured to provide identity services, such as access management and authorization services in cloud infrastructure system 1000. In some embodiments, identity management module 1028 may control information about customers who wish to utilize the services provided by cloud infrastructure system 1002. Such information can include information that authenticates the identities of such customers and information that describes which actions those customers are authorized to perform relative to various system resources (e.g., files, directories, applications, communication ports, memory segments, etc.) Identity management module 1028 may also include the management of descriptive information about each customer and about how and by whom that descriptive information can be accessed and modified.

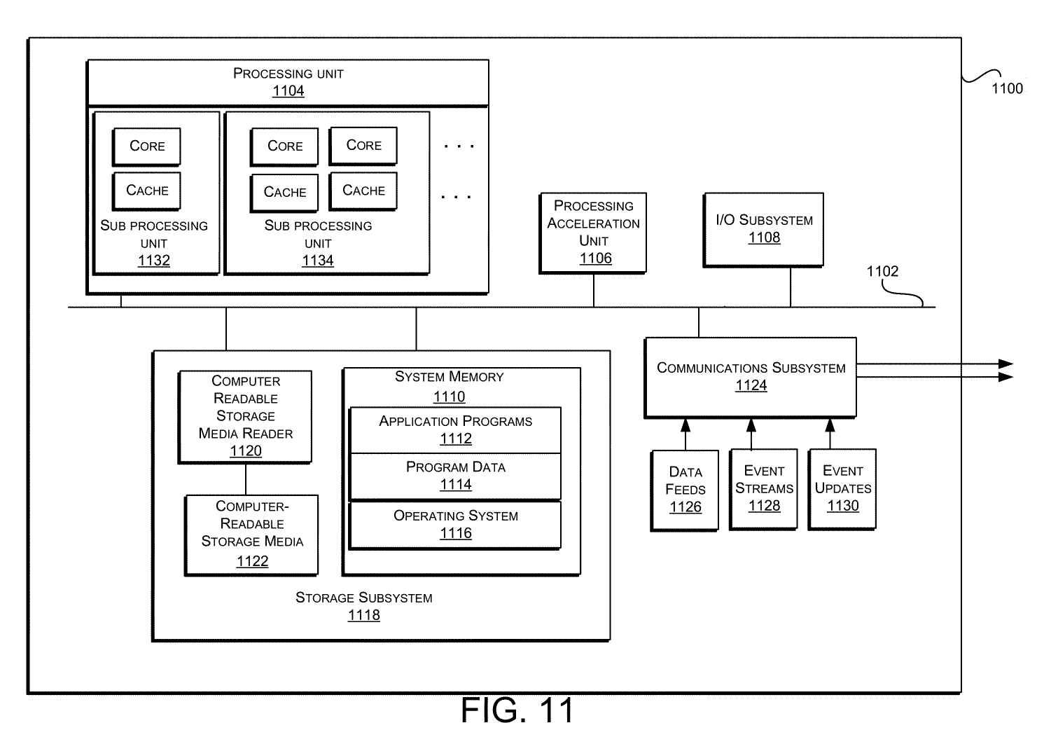

FIG. 11 illustrates an exemplary computer system 1100, in which various embodiments of the present invention may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 11 OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118.

These software modules or instructions may be executed by processing unit 1104. Storage subsystem 1118 may also provide a repository for storing data used in accordance with the present invention.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based

SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 1102.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method comprising:
at a server computer having a processor and a memory:
receiving a first set of one or more policies that manage participants of communications associated with a first organization, wherein the first set of policies are designed as sharable with other organizations;
storing the first set of policies in the memory;
receiving a second set of one or more policies that manage participants of communications associated with a second organization, wherein the second set of policies are designed as sharable with other organizations;
storing the second set of policies in the memory;
detecting an event associated with a communication between a first participant of the first organization and a second participant of the second organization that involves a third participant of a third organization;
determining that participation of the third participant in the communication violates one or more policies in the first set of policies or the second set of policies; and
managing the participation of the third participant in the communication based on the one or more policies.

2. The method of claim 1 wherein detecting the event associated with the communication between the first participant of the first organization and the second participant of the second organization that involves the third participant of the third organization comprises detecting initiation of phone call.

3. The method of claim 1 wherein detecting the event associated with the communication between the first participant of the first organization and the second participant of the second organization that involves the third participant of the third organization comprises detecting that the third participant has been invited to a chat session.

4. The method of claim 1 wherein detecting the event associated with the communication between the first participant of the first organization and the second participant of the second organization that involves the third participant of the third organization comprises detecting that the third participant has been invited to a teleconference.

5. The method of claim 1 wherein managing the participation of the third participant in the communication based on the one or more policies comprises blocking the third participant.

6. The method of claim 1 wherein managing the participation of the third participant in the communication based on the one or more policies comprises logging the participation of the third participant.

7. The method of claim 1 wherein managing the participation of the third participant in the communication based on the one or more policies comprises requesting permission for the participation of the third participant.

8. A system comprising:
a processor; and
a memory storing a set of instructions that when executed by the processor cause the processor to:
receive a first set of one or more policies that manage participants of communications associated with a first organization, wherein the first set of policies are designed as sharable with other organizations;
receive a second set of one or more policies that manage participants of communications associated with a second organization, wherein the second set of policies are designed as sharable with other organizations;
detect an event associated with a communication between a first participant of the first organization and a second participant of the second organization that involves a third participant of a third organization;
determine that participation of the third participant in the communication violates one or more policies in the first set of policies or the second set of policies; and
manage the participation of the third participant in the communication based on the one or more policies.

9. The system of claim 8 wherein to detect the event associated with the communication between the first participant of the first organization and the second participant of the second organization that involves the third participant of the third organization the processor is caused to detect initiation of phone call.

10. The system of claim 8 wherein to detect the event associated with the communication between the first participant of the first organization and the second participant of the second organization that involves the third participant of the third organization the processor is caused to detect that the third participant has been invited to a chat session.

11. The system of claim 8 wherein to detect the event associated with the communication between the first participant of the first organization and the second participant of the second organization that involves the third participant of the third organization the processor is caused to detect that the third participant has been invited to a teleconference.

12. The system of claim 8 wherein to manage the participation of the third participant in the communication based on the one or more policies the processor is caused to block the third participant.

13. The system of claim 8 wherein to manage the participation of the third participant in the communication based on the one or more policies the processor is caused to log the participation of the third participant.

14. The system of claim 8 wherein to manage the participation of the third participant in the communication based on the one or more policies the processor is caused to request permission for the participation of the third participant.

15. A method comprising:
receiving, by a computer system, an event associated with a communication originating from a first user associated with a first organization;
determining, by the computer system, whether the communication violates a first set of one or more communication policies associated with the first organization;
accessing, by the computer system, a cloud-based service to determine whether the communication violates a second set of one or more communication policies associated with a second organization; and
managing, by the computer system, the communication based on the first set of policies and the second set of policies.

16. The method of claim 15 wherein accessing, by the computer system, the cloud-based service to determine whether the communication violates a second set of one or more communication policies associated with a second organization comprises:
requesting the second set of policies from the service; and
determining whether the communication violates the second set of policies.

17. The method of claim 15 wherein accessing, by the computer system, the cloud-based service to determine whether the communication violates a second set of one or more communication policies associated with a second organization comprises:
sending a request to the service for a determination; and
receiving a response indicating whether the communication violates the second set of policies.

18. The method of claim 15 wherein managing the communication based on the first set of policies and the second set of policies comprises blocking the communication.

19. The method of claim 15 wherein managing the communication based on the first set of policies and the second set of policies comprises allowing the communication.

20. The method of claim 15 wherein managing the communication based on the first set of policies and the second set of policies comprises logging, filtering, or modifying the communication.
